(19) United States
(12) Patent Application Publication
(10) Pub. No.: US 2012/0027995 A1
(43) Pub. Date: Feb. 2, 2012

(54) COATING STRUCTURE, CHEMICAL COMPOSITION FOR FORMING THE SAME, AND METHOD OF FORMING THE SAME

(76) Inventor: Chi-Hsiang Hung, Taoyuan (TW)

(21) Appl. No.: 13/271,254

(22) Filed: Oct. 12, 2011

Related U.S. Application Data
(62) Division of application No. 12/423,778, filed on Apr. 14, 2009.

(30) Foreign Application Priority Data
Dec. 31, 2008 (TW) 097151614

(51) Int. Cl. B32B 3/10

(52) U.S. Cl. 428/143

(57) ABSTRACT

A coating structure includes a UV-cured resin layer and a fluoride monomolecular layer. Organosilicon groups of organosilicon molecules extend from the surface of the resin layer. Wax fine powder and oxide nanoparticles emerge from the surface of the resin layer to form mountain-valley-like microstructures. Fluoride molecules of the fluoride monomolecular layer are chemically bonded with the surface of the resin layer to expose the fluoride groups. During the formation of the coating structure, the UV-curable resin layer is first partially cured, then the fluoride molecules are activated to chemically bond to the surface of the resin layer, and thereafter, the UV-curable resin layer is completely cured.

### CROSS REFERENCE TO RELATED APPLICATIONS

This is a division of U.S. application Ser. No. 12/423,778 filed Apr. 14, 2009, which is incorporated herein by reference.

### BACKGROUND OF THE INVENTION

1. Field of the Invention

The present invention relates to a coating structure, a chemical composition for forming the coating structure, and a method of forming the coating structure, and particularly to a coating structure having properties of antifouling, abrasion resistance, and high hardness, a chemical composition for forming the coating structure, and a method of forming the coating structure.

2. Description of the Prior Art

Conventionally, a high glossy layer is made of a UV (ultraviolet light)-curable transparent coating material (also referred to as UV clear paint), since the UV clear paint has a high solid content, a high cross-linkage density, and a low porosity for the resulting coating layer. The resulting coating layer basically has certain antifouling properties, and most pollutants on it can be wiped away with a small amount of cleaning liquid. However, it is not satisfied to simply employ the UV clear paint as the technology keeps improving. A small amount of auxiliary agent, such as silane and fluoride compound, having low surface energy, has ever been added into the UV clear paint, such that, during the dryness of the coating layer, the auxiliary agent will spontaneously floats on the surface of the coating layer, rendering the coating layer a short-termed antifouling effect. However, such additives are so small molecular compounds such that they tend to be lost in a long term, or the low surface energy groups cannot extend to the coating surface for rendering antifouling effect, due to the induction of bio-molecules. Accordingly, an ideal long-termed antifouling effect can not be achieved.

In addition to the enhancement of the antifouling effect of the coating layer formed of the UV clear paint, the coating layer per se can be further treated with, for example, a polishing block, a water-repellant cleaning agent for vehicle glass, and the like. However, there is a common disadvantage to the aforesaid treatments, i.e., the antifouling effect is short-termed and the gloss and hardness of the coating layer are affected. This is because the modification is just maintained by weak physical force, not chemical bonding.

Additionally, Taiwan Utility Model Patent No. 319150, issued on Sep. 21, 2007, discloses a fluoride film structure for protecting plastic substrate as shown in FIG. 1, in which a modified layer 2 which is an inorganic film mainly containing nano-sized silicon oxide or siloxane particles is formed on a plastic substrate 1, and a fluoride protection film 3 is formed on a surface of the modified layer 2. The modified layer 2 serves as an interface between the plastic substrate 1 and the fluoride protection film 3, such that the fluoride protection film 3 can be securely fixed on the plastic substrate 1 to lower the surface energy of the plastic substrate 1, for enhancing the antifouling effect. However, such protection film structure does not have high gloss due to the porous properties of the silicon oxide thin film.

Therefore, there is still a need for a novel coating structure having properties of high gloss, long-termed antifouling, and abrasion resistance, and a method of making the same.

### SUMMARY OF THE INVENTION

One objective of the present invention is to provide a coating structure, a chemical composition for forming the coating structure, and a method of forming the coating structure. The coating structure has excellent antifouling and anti-finger print properties for a long term in addition to high gloss and high abrasion resistance.

The coating structure according to the present invention comprises a UV-cured resin layer formed on a surface of a substrate to be coated and a fluoride monomolecular layer formed on a surface of the UV-cured resin layer. The UV-cured resin layer further comprises organosilicon molecules, wax fine powder, and oxide nanoparticles. The organosilicon molecules have organosilicon groups extending from the surface of the UV-cured resin layer. The wax fine powder and the oxide nanoparticles both emerge from the surface of the UV-cured resin layer to form mountain-valley-like microstructures. Fluoride molecules of the fluoride monomolecular layer are chemically bonded with the surface of the UV-cured resin layer to expose the fluoride groups.

The chemical composition for forming a coating layer according to the present invention comprises 100 weight parts of UV-curable resin; 0.01 to 5 weight parts of organosilicon molecules; 0.1 to 5 weight parts of wax fine powder of low surface energy; and 0.5 to 5 weight parts of oxide nanoparticles.

The method of forming a coating structure according to the present invention comprises steps of providing a mixture comprising a UV-curable resin, organosilicon molecules, a wax fine powder with low surface energy, and oxide nanoparticles; applying the mixture to a surface of a substrate to be coated to form a coating layer; heating the coating layer and allowing the coating layer to stand for a period of time to allow the organosilicon molecules, the wax fine powder with low surface energy, and the oxide nanoparticles to migrate to the surface of the coating layer; irradiating the coating layer with a first UV light to partially cure the coating layer; after partially curing the coating layer, applying a fluoride monomolecular layer to the coating layer and heating the coating layer to activate the fluoride molecules; and, after activating the fluoride molecules, irradiating the coating layer with a second UV light to completely cure the coating layer.

Compared with the conventional technology, in the present invention, the coating layer surface is rendered of the antifouling properties by being given a lotus-leaf-like biomimetic structure, and, furthermore, groups/moieties of low surface energy can be fixed on the external surface by means of chemical bonding the fluoride molecules with the underlying coating layer, such that the coating structure has excellent long-termed antifouling and anti-finger print properties in addition to high gloss and high abrasion resistance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional view illustrating a conventional coating structure;

FIG. 2 is a schematic cross-sectional view illustrating a coating structure according to the present invention;

FIG. 3 shows a schematic partial close-up view of FIG. 2;

FIG. 4 is a schematic view illustrating a biomimetic structure having lotus-leaf effect as the properties of the coating structure according to the present invention; and

FIG. 5 is a schematic view illustrating chemical bonding between the fluoride molecules and the surface of the resin layer.

### DETAILED DESCRIPTION

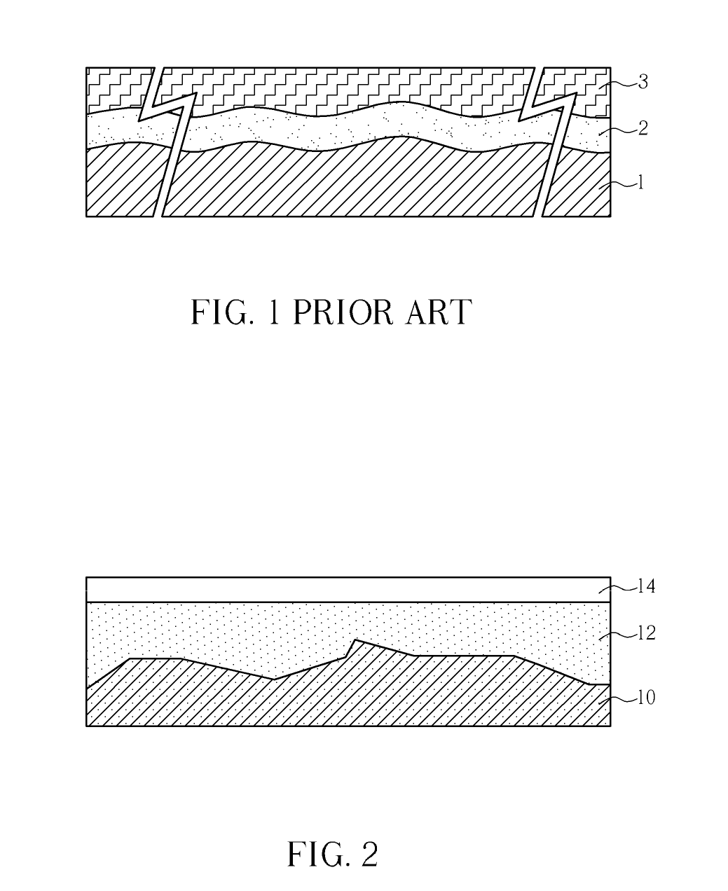

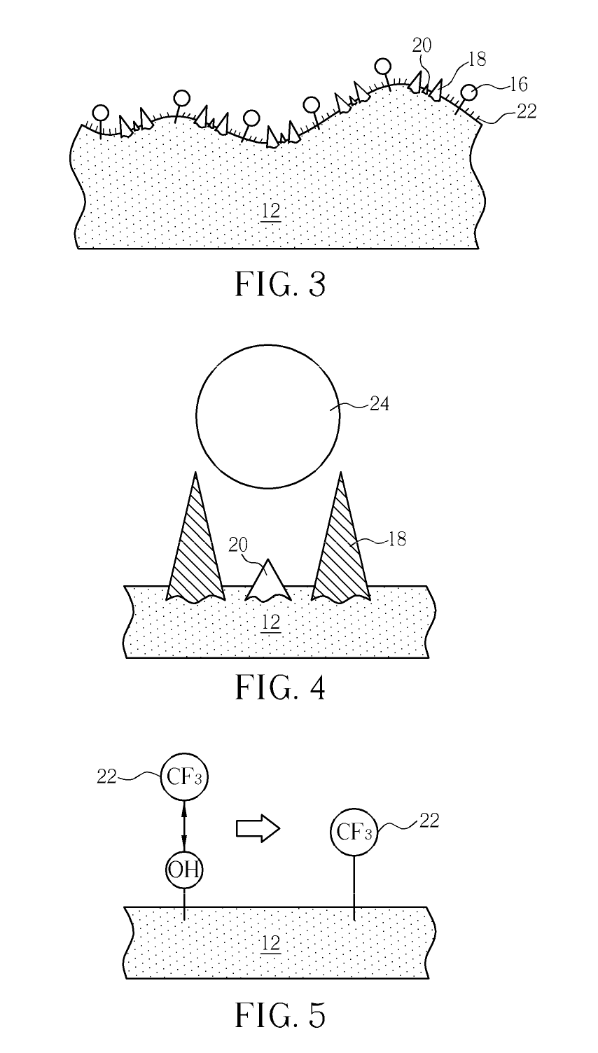

As shown in FIG. 2, the coating structure according to the present invention is formed on the surface of the substrate 10 to be coated. The coating structure according to the present invention includes a UV-cured resin layer 12 and a fluoride monomolecular layer 14 formed on a surface of the UV-cured resin layer 12. More specifically, as shown in FIG. 3, a schematic partial close-up view of FIG. 2, the UV-cured resin layer 12 further includes organosilicon molecules 16, wax fine powder 18, and oxide nanoparticles 20. The organosilicon groups of the organosilicon molecules 16 extend out from the surface of the UV-cured resin layer 12. The wax fine powder 18 and the oxide nanoparticles 20 both emerge from the surface of the UV-cured resin layer 12 to form mountain-valley-like microstructures. Fluoride molecules 22 of the fluoride monomolecular layer 14 are chemically bonded with the surface of the UV-cured resin layer 12, so as to allow the fluoride groups to be exposed to the external environment. It should be noted that the drawings serve only for illustration purposes and are not drawn to scale.

The method of forming the coating structure according to the present invention is described hereinafter. First, a chemical composition for forming a coating layer is provided. The chemical composition includes a UV-curable resin, organosilicon molecules, a wax fine powder with low surface energy, and oxide nanoparticles. The amounts of them for use may be for example 100 weight parts of the UV-curable resin; 0.01 to 5 weight parts, and preferably 0.01 to 2 weight parts of the organosilicon molecules; 0.1 to 5 weight parts, and preferably 0.1 to 2 weight parts of the wax fine powder with low surface energy; and 0.5 to 5 weight parts, and preferably 0.75 to 4 weight parts of the oxide nanoparticles.

The UV-curable resin, also called as UV clear paint, may include, but be not limited to, an acrylic polymer, a polyurethane (PU), a polyester, and the like. Preferably, the UV-curable resin may be cured to form a resin layer having a hardness of H or harder, a high glass transition temperature (T_{g}), and a high density, such that the UV-cured resin layer per se has a certain extent of antifouling effect. A mark thereon made by an oil marker can be easily removed just using a small amount of cleaner.

The organosilicon molecules are small organosilicon molecules having an organosilicon group and may be for example silanes, siloxanes, polyether modified organosilicon compounds, or polyester modified organosilicon compounds.

The wax fine powder is preferably a wax fine powder having low surface energy and may be, for example, a fine powder of polytetrafluoroethylene (PTFE), polyethylene (PE), polyamide, polypropylene (PP), PTFE/PE copolymer, or a combination thereof. The particle size of the wax fine powder may be preferably 10 to 50 microns. The wax fine powder is baked to a soften point and slightly melts, so as to distribute it over the surface of the coating layer. The resulting coating layer is of dry-slip touch feeling and anti-finger print properties, due to the use of the small molecules with low molecular weights.

The oxide nanoparticles are preferably nano-sized oxide particles having properties of high slip and anti-scratching, such as aluminum oxide, silicon oxide, zinc oxide (ZnO), or cerium oxide (CeO₂), so as to enhance the hydrophobic and lipophobic (or oleophobic) properties of the coating layer. The particle size is preferably 10 nanometers to 100 nanometers.

The aforesaid chemical composition is mixed to become a mixture by for example mechanical mixing. For example, the mixture is stirred for 5 minutes using a stirring machine at a low rotating speed (for example, 200 to 400 rpm) in advance. If the viscosity of the mixture is low, such as 2,000 centi-poises (cps) or less, the mixture is then stirred for 5 to 10 minutes using a homogenizer at a rotating speed ranging from 5000 to 9000 rpm. If the viscosity of the mixture is media or high, such as 2,000 cps or more, the mixture is then stirred for 10 to 15 minutes using a stirrer at a rotating speed ranging from 500 to 1000 rpm.

The mixture is applied to a surface of the substrate to be coated to form a coating layer. The thickness of the coating layer may be optional as desired, for example, 5 to 50 microns, and preferably, 5 to 25 microns. The application to form the coating layer may be accomplished by, for example, print coating or spray coating. The resulting coating layer should be smooth and glossy.

Thereafter, the coating layer is heated and allowed to stand for a period of time. The purpose of heating and standing is to allow the organosilicon molecules, the wax fine powder with low surface energy, and the oxide nanoparticles to migrate to the surface of the coating layer, and in the same time, to expel the solvent, if any, from the coating layer, and to facilitate leveling of the coating layer. Accordingly, the temperature and the period for the heating and the standing are not particularly limited as long as such purpose can be attained. For example, it may be baked at 60 to 80° C. for 30 to 180 minutes by a hot air blower or infer-ray (IR). In the baking step, the coating layer may be also dried.

Thereafter, the coating layer is irradiated with a UV light to be partially cured, i.e., not completely cured, for reserving some functional groups for use in the subsequent procedures. For instance, if the complete curing requires 100 to 1000 mJ/cm² of intensity of illumination, only 80% to 90% of the intensity of illumination is used for the partial curing, such that 10% to 20% of the functional groups (such as hydroxyl groups) can be retained to combine with the fluoride monomolecular layer in the later.

Thereafter, a monomolecular layer of fluoride is applied to the partially cured coating layer. The application may be performed by for example dip-coating, spray-coating, print, and the like. For instance, the partially-cured coating layer as well as the substrate underlying the coating layer is dipped into a fluoride solution to perform the dip-coating and stays for 10 to 30 seconds, to allow the fluoride to be adsorbed on the surface of the partially cured coating layer, and then is slowly pulled out from the solution at a speed of 50 to 2000 mm/minute. The environmental temperature is preferably controlled at 25±1° C. and the relative humidity is preferably controlled at 50±5%. The fluoride solution is essentially consisted of fluoride molecules and solvent. The fluoride molecules may be for example perfluoropolyether having a number average molecular weight (Mn) of 1000 or more, and the solvent may be organic solvent. For instance, a fluoride solution of the product EGC-1720 sold by 3M company, USA, may include 10% or less of perfluoropolyether, 5% or less of additives (such as catalysts, adhering improving agents, and the like), and 90% or more of organic solvent.

In addition, the fluorosilane having the following chemical formula may be also useful to serve as the fluoride molecules in the present invention:

R_{f}—[—R¹—SiY₃₋ₓR²ₓ]_{y}

wherein, R_{f} is a univalent or divalent polyfluoro-polyether group; R¹ is —C(O)NHR′, wherein R′ is an alkylene group; R² is a C₁-C₄ alkyl group; Y is a halo, C₁-C₄ alkoxy, or C₁-C₄ acyloxy group; x is number 2 or 1; and y is number 1 or 2. R_{f} may be for example —CF₂O(CF₂O)ₘ(C₂F₄O)ₚCF₂—, —C₃F₇O(CF(CF₃)CF₂O)ₚ(CF)(CF₃)—, —CF₃O(C₂F₄O)ₚCF₂—, —CF(CF₃)O(CF(CF₃)CF₂O)ₚ(CF₃)—, —CF₂O(C₂F₄O)ₚCF₂—, or —(CF₂)₃O(C₄F₈O)ₚ(CF₂)₃—, wherein, the average of m is 0 to 50, the average of p is 0 to 50, and m and p in a same moiety are not both 0 at the same time.

The fluoride monomolecular layer, coated on the outmost surface, is thin, such as about several nanometers to tens nanometers, to allow the —CF₃ groups to be fixed on the external surface of the coating layer. It is also required that The fluoride molecules have functional groups such as hydroxyl groups, to allow the fluoride molecules to chemically bond to the coating layer at its surface, such that the fluoride molecules are secured on the surface of the coating layer. The coating layer is namely the UV-curable resin, which preferably has a functional group for chemical bonding, such as a hydroxyl group.

Thereafter, the fluoride monomolecular layer-coated coating layer is heated to activate the fluoride. For instance, the aforesaid fluoride solution dip-coated coating layer is heated to activate the fluoride. After the fluoride molecules are applied on the coating layer, they must be heated to a certain temperature to activate the fluorides, such that the fluorides can be distributed on the coating layer surface as far as possible and chemically bond to the UV-curable resin. The temperature and the time period for the heating are not particularly limited as long as the fluoride molecules can be activated, and may be selected according to the material of the substrate. For example, for the plastic substrate to be coated, a temperature of 60 to 80° C. and a heating period of 30 to 180 minutes may be employed, and for the non-plastic substrate to be coated, a temperature of 120 to 150° C. and a heating period of 30 to 45 minutes may be employed.

Finally, the coating layer after being heated and activated is irradiated with a UV light to completely cure the UV-curable resin. That is, the coating layer is irradiated with the UV light with the reserved intensity of illumination (for example, 10% to 20% of the intensity of illumination for complete cure) to be completely cured. Such that, a surface having excellent and long-termed properties of high gloss and antifouling effect can be obtained.

The coating structure of the present invention is suitable for forming on a plastic or non-plastic substrate. The plastic material may be for example PC, PMMA, but not limited thereto. The non-plastic material may be for example glass, metal, and the like, but not limited thereto.

In the present invention, the UV-cured resin layer is employed as a matrix, and three types of additives: organosilicon, wax fine powder with low surface energy, and oxide nanoparticles serving as an auxiliary agent, are added thereto for achieving further improved antifouling and anti-finger print effect. These three types of additives have different functions. As shown in the partial close-up view in FIG. 3, the surface layer of the UV-cured resin layer 12 is still uneven and has fine gaps or hollows. Once filth or dirt clings thereto, it is not easy to remove it. Accordingly, the simply UV-cured resin layer can not have a good antifouling effect yet. The antifouling effect can be improved by the addition of organosilicon, such that the organosilicon groups of the organosilicon molecules can extend out from the surface of the resin layer. When the organosilicon groups extend out from the surface of the resin layer, a relatively optimal antifouling effect can be obtained. However, the organosilicon molecules are small and may tend to be lost when they randomly extend in company with the environmental factors such as drying rate, temperature and humidity. Accordingly, an ideal antifouling effect cannot be achieved by simply adding the organosilicon as an auxiliary agent. Therefore, in the present invention, not only the organosilicon but also the wax fine powder and the oxide nanoparticles are added and are allowed to emerge from the surface of the resin layer. For example, as shown in FIG. 4, the micro-sized wax fine powder 18 acts as mountains, and the oxide nanoparticles 20 act as valleys, for propping but not sticking the pollutant 24. Furthermore, the space between the mountains and the valleys is full of air such that the pollutant 24 hardly intrudes onto such structure. Such structure is a micro-nano sized composition and has a biomimetic structure like a lotus leaf; it can efficiently get rid of the clinging of pollutants.

The addition of the three types of auxiliary agents greatly improves antifouling effect of the coating structure. However, since the migration of the auxiliary agents to the surface during the film formation is resulted from a spontaneous thermodynamic mechanism, it is difficult to control the final surface status of the coating layer. In view of this problem, in the present invention, a fluoride monomolecular layer is further formed on the surface of the UV-cured resin layer. As shown in FIG. 5, the fluoride molecules 22 chemically bond with the hydroxyl groups of the resin located on the surface of the resin layer, to allow the fluoride-containing group with low surface energy (such as —CF₃) to dangle on the surface, such that more efficient and long-termed antifouling effect can be achieved, due to the chemical bonding, which is hardly broken.

The anti-finger print effect of the coating structure according to the present invention is evaluated. The pollutant is typically a water-oil mixture. If the coating layer is hydrophobic and lipophobic (or oleophobic), it can be deemed as to have antifouling properties. Accordingly, two types of evaluation are performed. One is to determine the water contact angle of the coating layer by an instrument. The greater the contact angle is, the stronger the hydrophobic property is. The other is to perform an ink test by marking the coating layer surface with an alcoholic marker with blue ink (for example, a Simbalion (Brand name) marker, Taiwan). If the ink forms non-continued drops and can be wiped out by a dry cloth without ink residue, the test is passed. The coating structure according to the present invention gives excellent results to both of the two types of evaluation.

### Example

100 grams of UV-curable resin (with a viscosity of 800 cps), 0.1 grams of organosilicon additive, 0.3 grams of PTFE wax fine powder, and 2.0 grams of aluminum oxide nanoparticles were stirred using a stirrer at a rotating speed of 200 rpm for 5 minutes, followed by using a high speed homogenizer at a rotating speed of 5000 rpm for 10 minutes. The mixed coating liquid was applied on a PC injected transparent plastic test plate by spray coating using a pressure of 2 bars with a spray head with a diameter of 1.1 mm, forming two crossed coating layers. The coated test plate was allowed to stand at 60° C. for dryness for 30 minutes, followed by an irradiation with an intensity of illumination of 270 mJ/cm² to perform a UV curing process. Such intensity was 90% of the intensity of illumination of 300 mJ/cm² required for complete curing. The resulting test plate was dipped in a fluoride solution consisting of 0.1 weight percents (wt %) of perfluoropolyether compound, 99.4 wt % of anhydride ethanol, and 0.5 wt % of catalyst. The test plate was allowed to stay in the solution for 30 seconds and then pulled up at a speed of 100 mm/minute. The temperature was controlled at 25±1° C. and the relative humidity was controlled at 50±5%. The test plate after being dip-coated with the fluoride solution was heated at 80° C. for activation for 30 minutes, followed by an irradiation with an intensity of illumination of 30 mJ/cm² to perform a UV curing process, giving the coating structure of the present invention. The resulting coating structure is of high gloss and dry-slip touch feeling. The surface hardness was determined as greater than 2 H (pencil hardness tester at 750 grams). The water contact angle was determined as 97.9°, indicating a hydrophobic property. The antifouling property was tested by marking with an oil marker (brand name: SIMBALION, Taiwan), and it was found that the ink shrank quickly, indicating an oleophobic property. The mark was easily wiped out with a cloth. Furthermore, after repeating 50 times of marking and wiping, no residue of ink was found.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coating structure comprising:
a UV-cured resin layer formed on a surface of a substrate to be coated, wherein the UV-cured resin layer further comprises organosilicon molecules having organosilicon groups extending from the surface of the UV-cured resin layer, and a wax fine powder and oxide nanoparticles both emerging from the surface of the UV-cured resin layer to form mountain-valley-like microstructures; and
a fluoride monomolecular layer formed on a surface of the UV-cured resin layer, wherein fluoride molecules of the fluoride monomolecular layer chemically bond with the surface of the UV-cured resin layer to expose the fluoride groups.

2. The coating structure of claim 1, wherein the substrate to be coated comprises plastic material.

3. The coating structure of claim 1, wherein the substrate to be coated comprises non-plastic material.
